(19) United States
(12) Patent Application Publication
(10) Pub. No.: US 2003/0081772 A1
(43) Pub. Date: May 1, 2003

(54) Parallel random number determinations for a stream cipher utilizing a common S-box

(76) Inventor: David M. Blaker, Chapel Hill, NC (US)

Correspondence Address: MYERS BIGEL SIBLEY & SAJOVEC, PO BOX 37428, RALEIGH, NC, 27627, US

(21) Appl. No.: 10/004,081

(22) Filed: Oct. 30, 2001

(51) Int. Cl. H04L 9/00

(52) U.S. Cl. 380/42

(57) ABSTRACT

Parallel generation of random values of a stream cipher utilizing a common S-box is provided. The generation of the values includes determining if a collision exists between accesses of the common S-box. The determination of the two sequential random values is then modified based on whether a collision exists between accesses of the common S-box. The stream cipher may be the ARC-4 cipher.

### FIELD OF THE INVENTION

The present invention relates to cryptographic processing, and more particularly, to stream ciphers such as the ARC-4 cipher.

### BACKGROUND OF THE INVENTION

Stream ciphers, such as ARC-4 and the RC-4 (trademark of RSA Security, Inc.), are common in conventional cryptographic techniques. ARC-4 is a variable-key size stream cipher and provides a keystream which may be independent of plaintext. These stream ciphers utilize an S-box having values of S[0], S[1], . . . S[255] with entries which are permutations of the numbers 0 through 255 where the permutation is a function of the variable-length key. Two counters, i and j, are also utilized and are initialized to zero. To generate a random byte, the following operations are performed:

i=(i+1)mod 256

j=(j+S[i])mod 256

swap S[i] and S[j]

t=(S[i]+S[j])mod 256

K=S[t]

The byte K may be XORed with the plaintext to produce ciphertext or XORed with the ciphertext to produce plaintext.

Conventionally, the S-box may be initialized by being filled with initial values such that S[0]=0, S[1]=1, . . . S[255]=255. Then another 256-byte array is filled with the key, repeating the key as necessary to fill the entire array K[0],K[1], . . . K[255]. The indexes i and j are set to zero and then the following operations may be performed:

for i=0 to 255:

j=(j+S[i]+K[i])mod 256

swap S[i] and S[j]

As is clear from the above discussion, the values in the S-box change as random values are generated and subsequent values are dependent on previous values. Furthermore, the algorithm may be further expanded to include larger bit values, such as 16 bit or 32 bit values with correspondingly larger S-boxes. However, such increases may also require additional memory to accommodate the larger S-boxes.

While in general, the ARC-4 stream cipher may provide relatively high speed generation of random values, such operations are typically carried out in recursive sequential operations where one random value is generated prior to determining the next random value. The ARC-4 algorithm may be particularly well suited to such a recursive approach as subsequent random values are dependent on previous random values. However, because of the recursive nature of the algorithm, it may be difficult to further increase the speed with which the random values are generated.

### SUMMARY OF THE INVENTION

Embodiments of the present invention provide for the parallel generation of random values of a stream cipher utilizing a common S-box. In particular embodiments of the present invention, the generation of the values includes determining if a collision exists between accesses of the common S-box utilized to determine a first of the two sequential random values and accesses of the common S-box utilized to determine a second of the two sequential random values. The determination of the two sequential random values is then modified based on whether a collision exists between accesses of the common S-box. In particular embodiments of the present invention, the stream cipher is the ARC-4 cipher.

In further embodiments of the present invention, the generation of the random values includes determining if a collision exists between accesses of the common S-box utilized to determine a first portion of the first of the two sequential random values and accesses of the common S-box utilized to determine a second portion of the first of the two sequential random values and determining if a collision exists between accesses of the common S-box utilized to determine a first portion of the second of the two sequential random values and accesses of the common S-box utilized to determine a second portion of the second of the two sequential random values.

In particular embodiments of the present invention, the determination of whether a collision exists includes determining a state associated with the determination of the at least two sequential random values, comparing values of counters utilized determining the at least two sequential random values and detecting a collision based on the determined state and the compared values. In certain embodiments, at least two states are associated with the determination of the sequential random values and the counters associated with the sequential values include first and second i counter values, first and second j counter values and first and second t counter values. In such embodiments, a first collision is detected if the determined state is the first state and the second i counter values equals the first j counter value. A second collision is detected if the determined state is the first state and the second j counter values equals the first i counter value. A third collision is detected if the determined state is the first state and the second j counter values equals the first j counter value. A fourth collision is detected if the determined state is the second state, the second j counter values equals the first t counter value. A fifth collision is detected if the determined state is the second state and the second t counter values equals the first i counter value and the second j counter value is not equal to the first i counter value.

Furthermore, the determination of the sequential random values may be modified by utilizing an S-box value corresponding to the first i counter as the S-box value corresponding to the second i counter if the first collision is detected. An S-box value corresponding to the first j counter may be utilized as the S-box value corresponding to the second j counter and the write of an S-box value corresponding to the first j counter to a location in the S-box corresponding to the first i counter prevented if the second collision is detected. An S-box value corresponding to the first i counter as the S-box value corresponding to the second j counter may be utilized and the writing of an S-box value corresponding to the first i counter to a location in the S-box corresponding to the first j counter prevented if the third collision is detected. An S-box value corresponding to the second j counter may be utilized as the S-box value corresponding to the first t counter if the fourth collision is detected. An S-box value corresponding to the second j counter may be utilized as the S-box value corresponding to the first t counter if the fifth collision is detected.

In still further embodiments of the present invention, a sixth collision is detected if the determined state is the second state and the first i counter value equals the first t counter value and a seventh collision detected if the determined state is the second state and the second t counter values equals the second i counter value. In such embodiments, the determination of the sequential random values may be modified by utilizing an S-box value corresponding to the first j counter as the S-box value corresponding to the first t counter if the sixth collision is detected and utilizing an S-box value corresponding to the second j counter as the S-box value corresponding to the second t counter if the seventh collision is detected.

In additional embodiments of the present invention, a system for determining sequential random values in parallel includes a multi-access memory which contains S-box values, a collision detection/number generation circuit which carries out parallel determinations for at least two sequential random values utilizing the S-box values and a state machine circuit operably associated with the collision detection/number generation circuit which controls the sequence of the determination of the sequential random values. In such embodiments, the collision detection/number generation circuit may be configured to include an i counter containing a value i[n] and aj counter containing a value j[n]. The collision detection/number generation circuit may be further configured to, responsive to the state machine being in state 0, initiate a read operation of the multi-access memory device from addresses i[n]+1 and i[n]+2. Responsive to the state machine being in state 1, the values of S[i[n]+1] and S[i[n]+2] are received from the multi-access memory, values for j[n+1] and j[n+2] determined utilizing the values from the multi-access memory and the value of j[n], read operations of the multi-access memory are initiated at the addresses of j[n+1] and j[n+2] and write operations are initiated to the multi-access memory to write the values of S[i[n]+2] and S[i[n]+1] to addresses j[n+1] and j[n+2] respectively. Responsive to the state machine being in state 2, the values of S[j[n+1]] and S[j[n+2]] are received from the multi-access memory, read operations of the multi-access memory are initiated at addresses S[i[n]+1]+S[j[n+1]] and at address S[i[n]+2]+S[j[n+2]], and write operations are initiated to write S[j[n+1]] and S[j[n+2]] to addresses i[n]+1 and i[n]+2 respectively. Responsive to the state machine being in state 3, the results of the read operations from addresses (S[i[n]+1]+S[j[n+1]]) and (S[i[n]+2]+S[j[n+2]]) are received from the multi-access memory to provide the at least two sequential random values.

In further embodiments of the present invention, the collision detection/number generation circuit is further configured to, responsive to the state machine being in state 3, update the values of i[n] and j[n] with the values of i[n]+2 and j[n+2] respectively and initiate read operations from the multi-access memory from addresses i[n]+1 and i[n]+2 utilizing the updated i[n] value.

The collision detection/number generation circuit may also be configured to compare values utilized to determine the at least two sequential random values and detect a collision based on the state of the state machine and the compared values. In such embodiments, the collision detection/number generation circuit is further configured to detect a first collision if the state machine is in state 1 and the value of i[n]+2 equals the value of j[n+1], detect a second collision if the state machine is in state 1 and the value of j[n+2] equals the value of i[n]+1, detect a third collision if the state machine is in state 1 and the value of j[n+2] equals the value of j[n]+1, detecting a fourth collision if the state machine is in state 2 and the value of j[n+2] equals the value of S[i[n]+1]+S[j[n+1]], detect a fifth collision if the state is in state 2 and the value of S[i[n]+2]+S[j[n+2]] equals the value of i[n]+1 and the value of j[n+2] is not equal to the value of i[n]+1, detect a sixth collision if the state machine is in state 2 and the value of i[n]+1 the value of S[i[n]+1]+S[j[n+1]] and detect a seventh collision if the state machine is in state 2 and the value of S[i[n]+2]+S[j[n+2]] equals the value of i[n]+2.

Furthermore, the collision detection/number circuit may be further configured to utilize the value of S[i[n]+1] as the value of S[i[n]+2] if the first collision is detected, utilize the value of S[j[n+1]] as the value of S[j[n+2]] and prevent writing S[j[n+1]] to the address of i[n]+1 if the second collision is detected, utilize the value of S[i[n]+1] as the value of S[j[n+2]], prevent writing S[i[n]+1] to the address of j[n+1] if the third collision is detected, utilize the value of S[j[n+2]] as the value of S[S[i[n]+1]+S[j[n+1]] if the fourth collision is detected, utilize the value of S[j[n+1]] as the value of S[S[i[n]+2]+S[j[n+2]] if the fifth collision is detected, utilize the value of S[j[n+1]] as the value of S[S[i[n]+1]+S[j[n+1]] if the sixth collision is detected and utilize the value of S[j[n+2]] as the value of S[S[i[n]+2]+S[j[n+2]] if the seventh collision is detected.

As will further be appreciated by those of skill in the art, the present invention may be embodied as methods, apparatus/systems and/or computer program products.

### BRIEF DESCRIPTION OF THE DRAWINGS

FIG. 1 is a block diagram of a stream cipher system incorporating embodiments of the present invention;

FIGS. 2A, 2B and 2C are block diagrams of particular embodiments of the present invention; and

FIG. 3 is a flowchart illustrating operations for collision detection and correction according to embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by those of skill in the art, the present invention can take the form of an entirely hardware embodiment, an entirely software (including firmware, resident software, micro-code, etc.) embodiment, or an embodiment containing both software and hardware aspects. Furthermore, the present invention can take the form of a computer program product on a computer-usable or computer-readable storage medium having computer-usable or computer-readable program code means embodied in the medium for use by or in connection with an instruction execution system. In the context of this document, a computer-usable or computer-readable medium can be any means that can contain, store, communicate, propagate, or transport the program for use by or in connection with the instruction execution system, apparatus, or device.

The computer-usable or computer-readable medium can be, for example, but is not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a removable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner if necessary, and then stored in a computer memory.

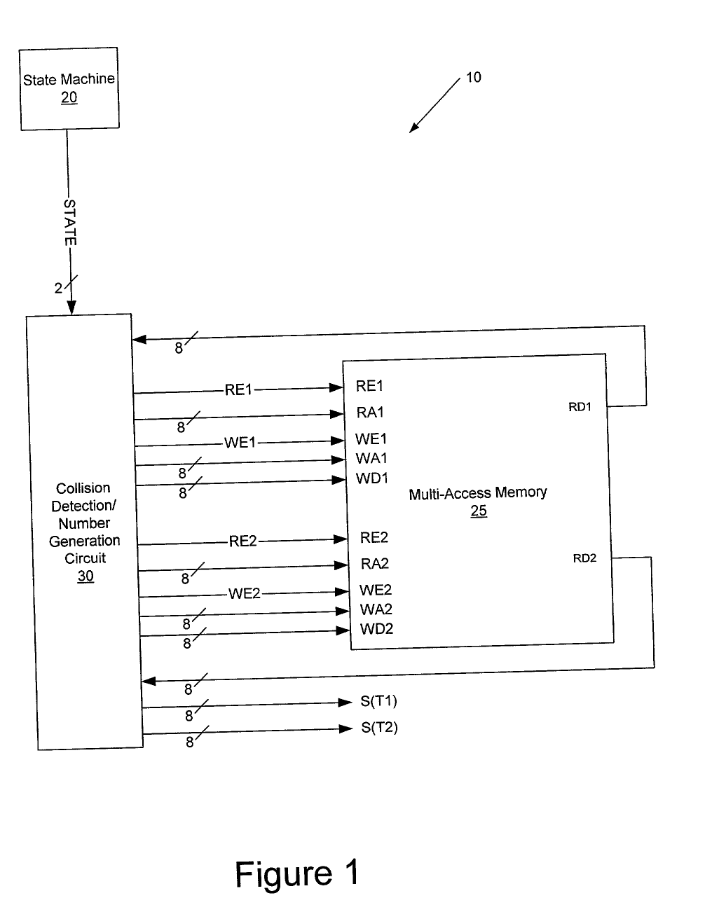

The present invention can be embodied as systems, methods, and/or computer program products for parallel generation of multiple random values for a stream cipher. In particular embodiments of the present invention, the stream cipher is the ARC-4 algorithm. Embodiments of the present invention will now be described with reference to FIGS. 1 through 3 which are flowchart, schematic and block diagram illustrations of parallel random value generation utilizing a common S-Box which incorporate embodiments of the present invention. It will be understood that each block of the flowchart illustrations and/or block and/or schematic diagrams, and combinations of blocks in the flowchart illustrations and/or block and/or schematic diagrams, can be implemented by computer program instructions. These program instructions may be provided to a processor to produce a machine, such that the instructions which execute on the processor create means for implementing the functions specified in the flowchart and/or block and/or schematic diagram block or blocks. The computer program instructions may be executed by a processor to cause a series of operational steps to be performed by the processor to produce a computer implemented process such that the instructions which execute on the processor provide steps for implementing the functions specified in the flowchart and/or block and/or schematic diagram block or blocks.

Accordingly, blocks of the flowchart illustrations and/or block and/or schematic diagrams support combinations of means for performing the specified functions, combinations of steps for performing the specified functions and program instruction means for performing the specified functions. It will also be understood that each block of the flowchart illustrations and/or block and/or schematic diagrams, and combinations of blocks in the flowchart illustrations and/or block diagrams, can be implemented by special purpose hardware-based systems which perform the specified functions or steps, or combinations of special purpose hardware and computer instructions.

FIG. 1 illustrates particular embodiments of the present invention which may be utilized for the parallel generation of random values for utilization in a stream cipher, such ARC-4, utilizing a single S-box. As seen in FIG. 1, a system for random value generation 10 includes a state machine 20, a collision detection circuit/number generation circuit 30 and a dual-port memory 25. In particular embodiments of the present invention, the random value generation system 10 determines the following:

i[n+1]=i[n]+1

j[n+1]=j[n]+S[i[n+1]]

swap S[i[n+1]] and S[j[n+1]]

t[n+1]=(S[i[n+1]]+S[j[n+1]])

K1=S[t[n+1]]

i[n+2]=i[n+1]+1

j[n+2]=j[n+1]+S[i[n+2]]

swap S[i[n+2]] and S[j[n+2]]

t[n+2]=(S[i[n+2]]+S[j[n+2]])

K2=S[t[n+2]]

where K1 and K2 are two random values generated substantially in parallel, i is a first index, j is a second index, t is a third index into the S-box (S) which is stored in the multi-access memory 25 and n is the number of previously generated random values. The state machine 20 keeps track of where in the generation process the collision detection/number generation circuit 30 is and controls the collision detection/number generation circuit 30 to access the multi-access memory 25 to obtain the S values and perform the swap operations.

In particular embodiments, the state machine may provide 4 states which are referred to herein as State 0, State 1, State 2 and State 3. State 0 is utilized to initialize the system 10 and the state machine 20 cycles through States 1, 2, and 3 to perform the above operations. The S-box may be initialized as described above by storing the values in the multi-access memory 25. Such operations may be carried out in a conventional manner by generating the 256 value array and loading the array into the multi-access memory 25. Such a generation may take place outside of the system 10 or may be incorporated into the system 10. Furthermore, initial j and i values may also be established in state 0 by, for example, setting them to zero.

Operations of the state machine 20, the collision detection/number generation circuit 30 and the multi-access memory 25 are illustrated in Table 1 below.

TABLE 1
State Operations

| State | Operation |
|---|---|
| 0 | Initiate read on port 1 at address i + 1 |
| | Initiate read on port 2 at address i + 2 |
| 1 | S[i1] data available on RD1 |
| | Initiate read on port 1 at j + S[i1] |
| | Initiate write to port 1 of S[i1] at address j + S[i1] |
| | S[i2] data available on RD2 |
| | Initiate read on port 2 at j + S[i1] + S[i2] |
| | Initiate write to port 2 of S[i2] at j + S[i1] + S[i2] |
| 2 | S[j1] data available on RD1 |
| | Initiate write to port 1 of S[j1] at address i0 + 1 |
| | Initiate read from port 1 at address S[i1] + S[j1] |
| | S[j2] data available on RD2 |
| | Initiate write to port 2 of S[j2] at i0 + 2 |
| | Initiate read from port 2 at address S[i2] + S[j2] |
| 3 | S[t1] data available on RD1 |
| | Increment i by 2 and initiate reading from port 1 at i + 1 |
| | Set j to j2 |
| | S[t2] data available on RD2 |
| | Initiate reading from port 2 at i + 2 |

As is seen from Table 1, the values of i[n+1]=i[n]+1 and i[n+2]=i[n+1]+1 are determined by the collision detection/number generation circuit 30 in states 0 and 3 so as to provide the read address for reading S[i[n+1]] and S[i[n+2]] from the multi-access memory 25.

In state 1, the values of S[i[n+1]] and S[i[n+2]] are available at the output of the multi-access memory 25. The collision detection/number generation circuit 30 utilizes these values to determine j[n+1] and j[n+2]. Thus, j[n+1] is determined by determining j[n]+S[i[n+1]] and j[n+2] is determined by determining j[n]+S[i[n+1]]+S[i[n+2]]. Reads from the multi-access memory are begun at the addresses of j[n+1] and j[n+2]. Writes of the S[i[n+2]] and S[i[n+1]] to j[n+1] and j[n+2] respectively are also performed to begin the swap operations to swap S[i[n+1]] and S[j[n+1]] and swap S[i[n+2]] and S[j[n+2]]. Such read and write operations may be overlapped because of the latency of a write operation in the multi-access memory such that the same address may be read from and written to at the same time.

In state 2, the swap operations are completed and the read operations for determining K1=S[t[n+1]] and K2=S[t[n+2]] are begun. Thus, read operations are begun at address (S[i[n+1]]+S[j[n+1]]) and at address (S[i[n+2]]+S[j[n+2]]). Also write operations writing S[j[n+1]] and S[j[n+2]] to addresses i[n+1] and i[n+2] respectively are performed to complete the swap operation of swap S[i[n+1]] and S[j[n+1]] and swap S[i[n+2]] and S[j[n+2]].

In state 3, the results of the read operations from addresses t[n+1] and t[n+2] are available from the multi-access memory 25 and the results of these read operations are provided as the two random values which have been concurrently generated. The values of i and j are updated to i+2 and j+2 respectively for the next random value determination and read operations from addresses i+1 and i+2, (utilizing the updated i value) are begun to initiate the next random value determination. Operations then return to state 1 and the process is repeated.

While in many situations, the above operations generate correct values for K1 and K2, in certain situations a collision between the read and write operations may occur which, unless compensated for, results in incorrect current and/or subsequent values. For example, race conditions may exist between the performance of the swap operations for one byte (e.g. the n+1 byte) which affect the results of the subsequent byte (e.g. the n+2 byte). For the multi-access memory 25, such collisions occur in 7 instances. If i[n+2]=j[n+1] in state 1, a collision occurs. This collision may be corrected by setting j[n+2]=j[n+1]+S[i[n+1]] such that the read is performed from the correct address. If j[n+2]=i[n+1] in state 1, a collision also occurs. This collision may be corrected by setting S[j[n+2]]=S[j[n+1]] and preventing the write operation of S[j+1]. If j[n+2]=j[n+1] in state 1, a collision occurs. This collision may be corrected by setting S[i[n+2]]=0, S[j[n+2]]=S[i[n+1]] and preventing the write of S[i[n+1]]. In state 2, if t[n+1]=i[n+1], a collision occurs. This collision may be corrected by setting S[t[n+1]]=S[j[n+1]]. If t[n+1]=j[n+2] in state 2, a collision occurs. This collision may be corrected by setting S[t[n+1]]=S[j[n+2]]. If t[n+2]=i[n+1] in state 2, a collision occurs. This collision may be corrected by setting S[t[n+2]]=S[j[n+1]]. Thus, utilizing the operations described above, the random values K1 and K2 may be generated in parallel utilizing a single S-box stored in a common memory.

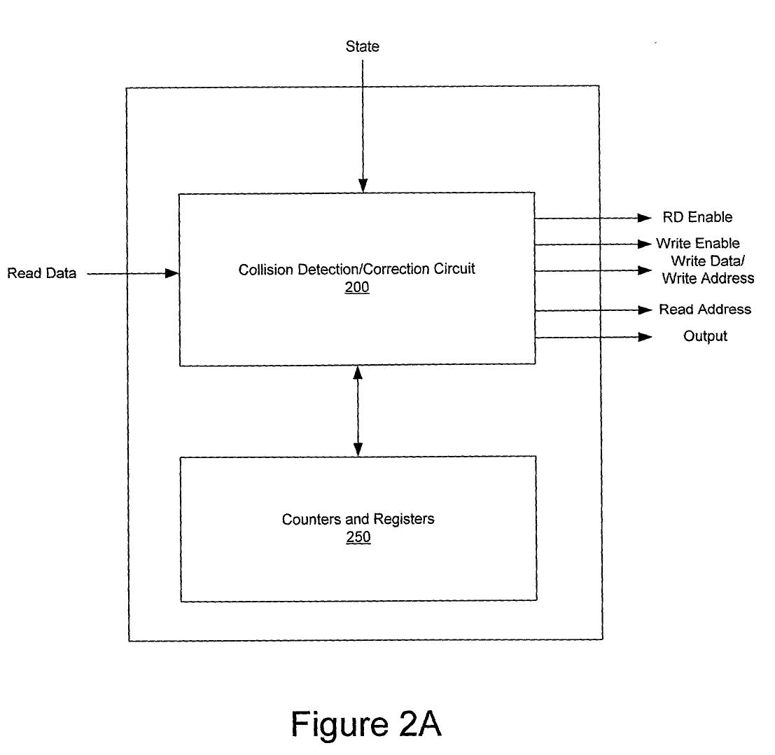

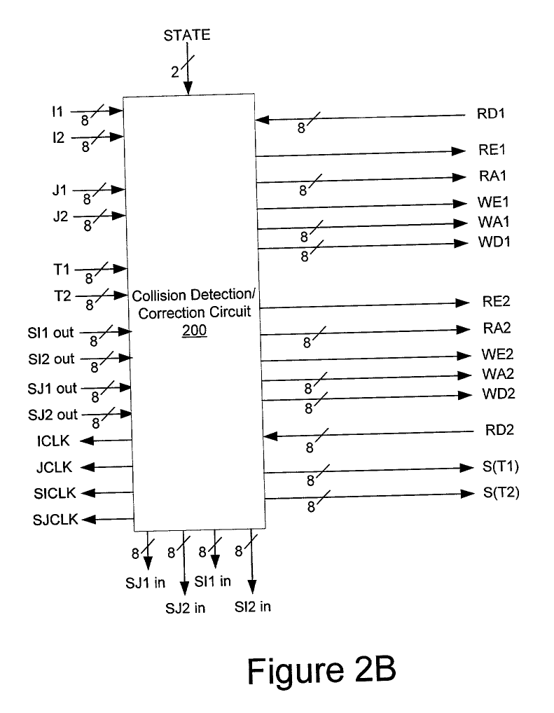

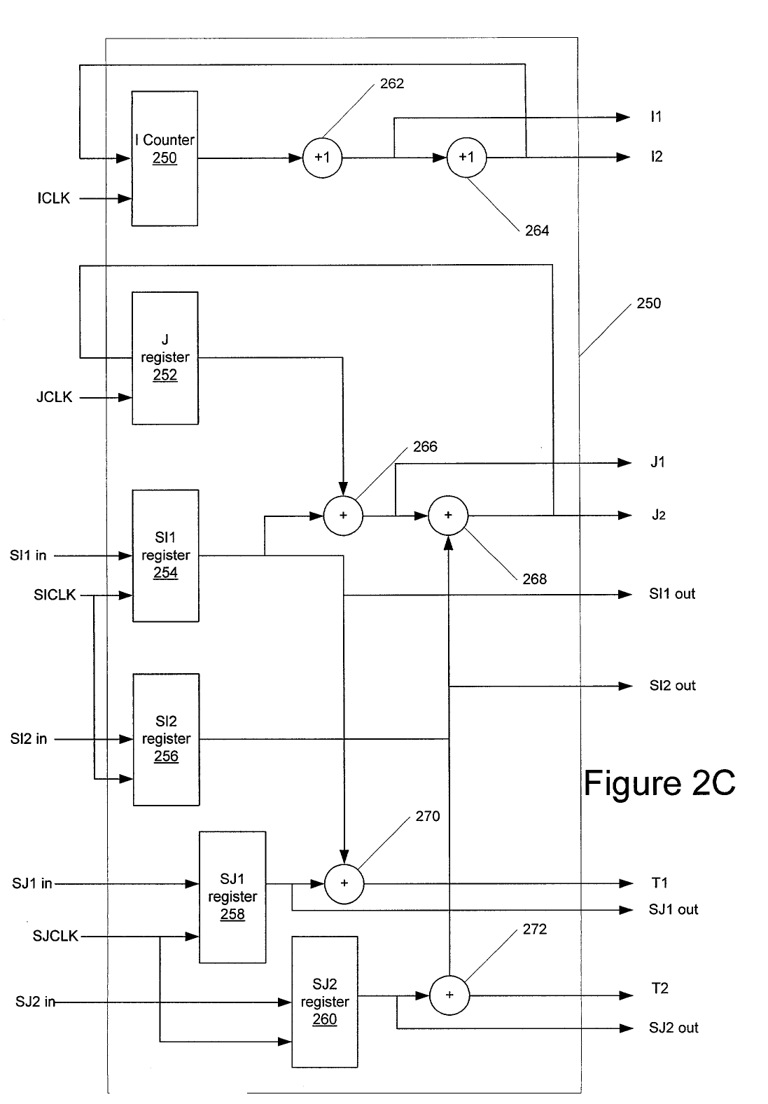

FIGS. 2A, 2B and 2C illustrate additional embodiments of the present invention. FIG. 2A illustrates in more detail, the collision detection/number generation circuit 30 of FIG. 1. As seen in FIG. 2A, the collision detection/number generation circuit 30 may include a collision detection circuit 200 and registers 250 for storing the I and j counter values, the S values and the T values.

As seen in FIG. 2B, a collision detection/collision correction circuit 200 may receive read data from RD1 and RD2 of the multi-access memory 25. The collision detection/correction circuit 200 also provides read enable signals RE1 and RE2 and read address data RA1 and RA2 to the multi-access memory 25. The collision detection/correction circuit 200 also receives state information from the state machine 20 and receives values of I1, I2, J1, J2, T1 and T2 corresponding to i[n+1], i[n+2], j[n+1] and j[n+2], respectively. The collision detection/correction circuit 200 further provides clock signals ICLK, JCLK, S1CLK and S2CLK and receives and provides S values to the storage devices of FIG. 2C. The collision detection/correction circuit 200 also outputs the random values as S(T1) and S(T2).

As seen in FIG. 2C, an I Counter 250 stores the value of i[n] from which the adder 262 generates the value of I1 (i.e. i[n]+1) and the adder 264 generates the value I2 (i.e. i[n]+2). The I Counter 250 may be incremented by 2 under the control of the collision detection/collision correction circuit 200 through the selective application of ICLK. The J register 252 stores the value of j[n] and may be selectively updated under the control of the collision detection/collision correction circuit 200 through the selective application of JCLK. The adder 266 adds the value of the J register 252 with the value of the SI1 register 254 (which corresponds to S[i[n]+1]]) to provide the J1 value (i.e. j[n+1]). Similarly, the adder 268 adds output by the adder 266 with the value of the SI2 register 256 (which corresponds to S[i[n]+2]]) to provide the J2 value (i.e. j[n+2]).

As mentioned above, the SI1 254 register and the SI2 register 256 store the values of S[i[n]+1] and S[i[n]+2] which are provided as SI1 in and SI2 in by the collision detection/collision correction circuit 200. The SI1 register 254 and the SI2 register 256 may be selectively loaded with values under the control of the collision detection/collision correction circuit 200 through the selective application if SICLK. Similarly, the SJ1 258 register and the SJ2 register 260 store the values of S[j[n+1]] and S[j[n+2]] which are provided as SJ1 in and SJ2 in by the collision detection/collision correction circuit 200. The SJ1 register 258 and the SJ2 register 260 may be selectively loaded with values under the control of the collision detection/collision correction circuit 200 through the selective application of SJCLK.

The adder 270 adds the value in the SI1 register 254 and the value in the SJ1 register 258 to provide the T1 value (i.e. t[n+1]). The adder 272 adds the value in the SI2 register 256 and the value in the SJ2 register 260 to provide the T2 value (i.e. t[n+2]).

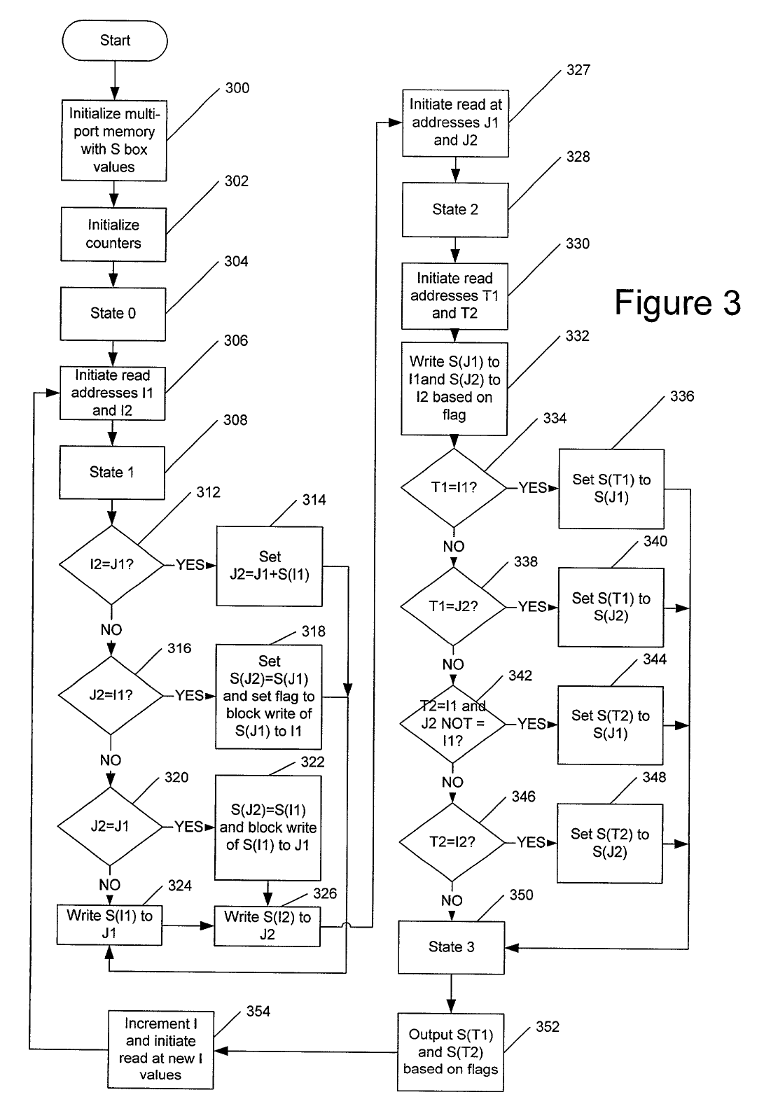

Operations of the system illustrated in FIGS. 2A, 2B and 2C will now be described with reference to FIG. 3. As seen in FIG. 3, the multi-access memory 25 is loaded with the initial S-box values (block 300). The I counter 250 and J register 252 are initialized to their starting values (block 302) and the state machine 20 enters state 0 (block 304). In state 0, the collision detection/correction circuit 200 initiates read at the addresses specified by the values I1 and I2 and sets RE1 to active and places I1 on RA1 and I2 on RA2 (block 306). The state machine 25 then enters state 1 (block 308).

In state 1, RD1 and RD2 contain the values at addresses I1 and I2 respectively. The collision detection/correction circuit 200 compares the I2 value with the J1 value (block 312) and if they are equal, sets J2 equal to J1+S[i[n]+1](block 314) to correct the read of S[j[n+2]] which would otherwise be corrupted and operations continue with block 324. If I2 and J1 are not equal (block 312), the collision detection/correction circuit 200 compares the J2 value with the I1 value (block 316) and if they are equal, sets the value of S[j[n+2]] equal to the value of S[j[n+1]] and sets a flag to block the write of S[j[n+1]] to the i[n]+1 address (block 318) and operations continue with block 324. Such may be accomplished by utilizing the values from SJ1 out as the value for both S[j[n+2]] and S[j[n+1]].

If J2 and I1 are not equal (block 316), the collision detection/correction circuit 200 compares J2 and J1 (block 320) and if equal, sets the value of S[j[n+2]] to S[i[n]+1] (block 322) and operations continue with block 326 to block the write of S[i[n]+1] to the address j[n+1]. This maybe accomplished by setting the value of SJ2 to the value of SI1 out in state 2.

In block 324, if reached, the collision detection/correction circuit 200 writes the value of S[i[n]+1] (i.e. the value from SI1 out) to the address j[n+1] and in block 326 writes the value of S[i[n]+2] (i.e. the value from S12 out) to the address j[n+2]. Such writes may be accomplished by placing the appropriate write data on WD1 and WD2 and the appropriate addresses at WA1 and WA2 and activating WE1 and WE2. The collision detection/correction circuit 200 also initiates reads at the addresses specified by the values on J1 and J2 by placing J1 on RA1 and J2 on RA2 (block 327).

The state machine 20 next enters state 2 (block 328). In state 2, the collision detection/correction circuit 200 initiates reads at the addresses specified by the values T1 and T2 by placing T1 on RA1 and T2 on RA2 (block 330). In state 2, RD1 and RD2 contain the values at addresses J1 and J2 respectively. The collision detection/correction circuit 200 selectively initiates writes to the addresses I1 and I2 (block 332). If the flag was not set in block 322, then the values of S[j[n+1]] and S[j[n+2]] are written to addresses i[n]+1 and i[n]+2, respectively (block 332). If the flag was set in block 322, then only the value of S[j[n+2]] is written to address i[n]+2 (block 332). Such may be accomplished by selectively placing the values of SJ1 out and SJ2 out on the WD1 and WD2 buses and the values of I1 and 12 on the WA1 and WA2 buses respectively and activating the WE1 and WE2 signals.

In state 2, the collision detection/correction circuit 200 also compares the value of T1 with the value of I1 (block 334). If equal, then a flag is set so that the output value of S(T1) is set to the value of S(J1) (block 336). If not equal (block 334), the value of T1 is compared to the value of J2 (block 338). If equal, then a flag is set so that the value of S(T1) is set to the value of S(J2) (block 340). If not equal (block 338), the value of T2 is compared to the value of I1 and the value of J2 is compared to the value of I1 (block 342). If T2 is equal to I1 and J2 is not equal to I1 (block 342), then a flag is set so that S(T2) is set to S(J1) (block 344). If not, then T2 is compared to I2 (block 346). If T2 and I2 are equal (block 346), then a flag is set to set S(T2) to S(J2) (block 348). The state machine 20 then enters state 3 (block 350).

In state 3, the collision detection/correction circuit 200 provides the appropriate output based on how the flags were set in state 2 (block 352). The I counter 250 and the J register 252 are then updated with the values of i[n]+2 and j[n+2] respectively (block 354) and operations continue with the initiation of a read utilizing the updated I counter 250 and J register 252 values (block 306).

While the present invention has been described with respect to the collision detection circuit, state machine and memory as separate functions, as will be appreciated by those of skill in the art, such functions may be provided as separate functions, objects or applications which may cooperate with each other. Furthermore, the present invention has been described with reference to particular sequences of operations. However, as will be appreciated by those of skill in the art, other sequences may be utilized while still benefiting from the teachings of the present invention. Thus, while the present invention is described with respect to a particular division of functions or sequences of events, such divisions or sequences are merely illustrative of particular embodiments of the present invention and the present invention should not be construed as limited to such embodiments.

Furthermore, while the present invention has been described with reference to particular register and bus configurations, as well as operations carried out in differing states, as will be appreciated by those of skill in the art in light of the present disclosure, other configurations may be utilized. For example, while the present invention has been described with reference to a 3 state cycle after exiting an initialization state, if additional read ports are utilized the number of states in the cycle could be reduced. For example, by doubling the read ports of the multi-access memory 25, additional read operations could be performed in parallel which may eliminate the need for state 3. Thus, the present invention is not to be construed as limited to such configurations but is intended to encompass other collision detection and correction circuits and implementations capable of detecting when values to and/or from a single memory containing a common S-box require adjustment and/or correction and for carrying out such adjustments and/or corrections.

Additionally, the present invention has been described with reference to the parallel generation of 2 random values. In the event that only a single random value is to be generated, for example, a “last” value for encrypting clear text having an odd number of bytes, then operations of the second parallel determination may be selectively blocked so that a single byte value is provided. Thus, for example, the collision detection/correction circuit 200 could block signals, reads and writes for the n+2 generation of the random value and appropriately disable comparisons such that only a single random value is generated and the I counter 250 and the J register 252 are appropriately updated to reflect the single generation of the random value.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A method of determining random values for an stream cipher, comprising:
determining at least two sequential random values in parallel utilizing a common S-box.

2. The method of claim 1, wherein the step of determining at least two sequential random values in parallel utilizing a common S-box further comprises the steps of:
determining if a collision exists between accesses of the common S-box utilized to determine a first of the two sequential random values and accesses of the common S-box utilized to determine a second of the two sequential random values; and
modifying the determination of the at least two sequential random values based on whether a collision exists between accesses of the common S-box.

3. The method of claim 2, wherein the step of determining if a collision exists comprises the steps of:
determining a state associated with the determination of the at least two sequential random values;
comparing values of counters utilized determining the at least two sequential random values; and
detecting a collision based on the determined state and the compared values.

4. The method of claim 3, wherein at least two states are associated with the determination of the at least two sequential random values, wherein the counters associated with at least two sequential values comprise first and second i counter values, first and second j counter values and first and second t counter values and wherein the step of detecting a collision comprises the steps of:
detecting a first collision if the determined state is the first state and the second i counter values equals the first j counter value;
detecting a second collision if the determined state is the first state and the second j counter values equals the first i counter value;
detecting a third collision if the determined state is the first state and the second j counter values equals the first j counter value;
detecting a fourth collision if the determined state is the second state, the second j counter values equals the first t counter value; and
detecting a fifth collision if the determined state is the second state and the second t counter values equals the first i counter value and the second j counter value is not equal to the first i counter value.

5. The method of claim 4, wherein the step of modifying the determination of the at least two sequential random values based on whether a collision exists between accesses of the common S-box comprises the steps of:
utilizing an S-box value corresponding to the first i counter as the S-box value corresponding to the second i counter if the first collision is detected;
utilizing an S-box value corresponding to the first j counter as the S-box value corresponding to the second j counter and preventing writing an S-box value corresponding to the first j counter to a location in the S-box corresponding to the first i counter if the second collision is detected;
utilizing an S-box value corresponding to the first i counter as the S-box value corresponding to the second j counter and preventing writing an S-box value corresponding to the first i counter to a location in the S-box corresponding to the first j counter if the third collision is detected;
utilizing an S-box value corresponding to the second j counter as the S-box value corresponding to the first t counter if the fourth collision is detected; and
utilizing an S-box value corresponding to the second j counter as the S-box value corresponding to the first t counter if the fifth collision is detected.

6. The method of claim 2, further comprising the steps of:
determining if a collision exists between accesses of the common S-box utilized to determine a first portion of the first of the two sequential random values and accesses of the common S-box utilized to determine a second portion of the first of the two sequential random values; and
determining if a collision exists between accesses of the common S-box utilized to determine a first portion of the second of the two sequential random values and accesses of the common S-box utilized to determine a second portion of the second of the two sequential random values.

7. The method of claim 6, wherein the step of determining if a collision exists comprises the steps of:
determining a state associated with the determination of the at least two sequential random values;
comparing values of counters utilized determining the at least two sequential random values; and
detecting a collision based on the determined state and the compared values.

8. The method of claim 7, wherein at least two states are associated with the determination of the at least two sequential random values, wherein the counters associated with at least two sequential values comprise first and second i counter values, first and second j counter values and first and second t counter values and wherein the steps of determining if a collision exists between accesses of the common S-box utilized to determine a first portion of the first of the two sequential random values and accesses of the common S-box utilized to determine a second portion of the first of the two sequential random values and determining if a collision exists between accesses of the common S-box utilized to determine a first portion of the second of the two sequential random values and accesses of the common S-box utilized to determine a second portion of the second of the two sequential random values comprises the steps of:
detecting a first collision if the determined state is the second state and the first i counter value equals the first t counter value; and
detecting a second collision if the determined state is the second state and the second t counter values equals the second i counter value.

9. The method of claim 8, wherein the step of modifying the determination of the at least two sequential random values based on whether a collision exists between accesses of the common S-box comprises the steps of:
utilizing an S-box value corresponding to the first j counter as the S-box value corresponding to the first t counter if the first collision is detected; and
utilizing an S-box value corresponding to the second j counter as the S-box value corresponding to the second t counter if the second collision is detected.

10. A system for determining sequential random values in parallel comprising:
a multi-access memory which contains S-box values;
a collision detection/number generation circuit which carries out parallel determinations for at least two sequential random values utilizing the S-box values; and
a state machine circuit operably associated with the collision detection/number generation circuit which controls the sequence of the determination of the sequential random values.

11. The system of claim 10, wherein the collision detection/number generation circuit is configured to include an i counter containing a value i[n] and a j counter containing a value j[n] and wherein the collision detection/number generation circuit is further configured to, responsive to the state machine being in state 0 initiate a read operation of the multi-access memory device from addresses i[n]+1 and i[n]+2;
responsive to the state machine being in state 1, receive the values of S[i[n]+1] and S[i[n]+2] from the multi-access memory, determine values for j[n+1] and j[n+2] utilizing the values from the multi-access memory and the value of j[n], initiate read operations of the multi-access memory at the addresses of j[n+1] and j[n]+2 and initiate write operations to the multi-access memory to write the values of S[i[n]+2] and S[i[n]+1] to addresses j[n+1] and j[n+2] respectively;
responsive to the state machine being in state 2, receive the values of S[j[n+1]] and S[j[n+2]] from the multi-access memory, initiate read operations of the multi-access memory at addresses S[i[n]+1]+S[j[n+1]] and at address S[i[n]+2]+S[j[n+2]], and initiate write operations to write S[j[n+1]] and S[j[n+2]] to addresses i[n]+1 and i[n]+2 respectively; and
responsive to the state machine being in state 3, receive the results of the read operations from addresses (S[i[n]+1]+S[j[n+1]]) and (S[i[n]+2]+S[j[n+2]]) are from the multi-access memory to provide the at least two sequential random values.

12. The system of claim 11, wherein the collision detection/number generation circuit is further configured to, responsive to the state machine being in state 3, update the values of i[n] and j[n] with the values of i[n]+2 and j[n+2] respectively and initiate read operations from the multi-access memory from addresses i[n]+1and i[n]+2 utilizing the updated i[n] value.

13. The system of claim 12, wherein the collision detection/number generation circuit is further configured to compare values utilized to determine the at least two sequential random values and detect a collision based on the state of the state machine and the compared values.

14. The system of claim 13, wherein the collision detection/number generation circuit is further configured to detect a first collision if the state machine is in state 1 and the value of i[n]+2 equals the value of j[n+1], detect a second collision if the state machine is in state 1 and the value of j[n+2] equals the value of i[n]+1, detect a third collision if the state machine is in state 1 and the value of j[n+2] equals the value of j[n]+1, detecting a fourth collision if the state machine is in state 2 and the value of j[n+2] equals the value of S[i[n]+1] +S[j[n+1]], detect a fifth collision if the state is in state 2 and the value of S[i[n]+2]+S[j[n+2]] equals the value of i[n]+1 and the value of j[n+2] is not equal to the value of i[n]+1, detect a sixth collision if the state machine is in state 2 and the value of i[n]+1 the value of S[i[n]+1]+S[j[n+1]] and detect a seventh collision if the state machine is in state 2 and the value of S[i[n]+2]+S[j[n+2]] equals the value of i[n]+2.

15. The system of claim 14, wherein the collision detection/number circuit is further configured to utilize the value of S[i[n]+1] as the value of S[i[n]+2] if the first collision is detected, utilize the value of S[j[n+1]] as the value of S[j[n+2]] and prevent writing S[j[n+1]] to the address of i[n+1] if the second collision is detected, utilize the value of S[i[n]+1] as the value of S[j[n+2]] and prevent writing S[i[n]+1] to the address of j[n+1] if the third collision is detected, utilize the value of S[j[n+2]] as the value of S[S[i[n]+1]+S[j[n+1]] if the fourth collision is detected, utilize the value of S[j[n+1]] as the value of S[S[i[n]+2]+S[j[n]+2]] if the fifth collision is detected, utilize the value of S[j[n+1]] as the value of S[S[i[n]+1]+S]j[n+1]] if the sixth collision is detected and utilize the value of S[j[n+2]] as the value of S[S[i[n]+2]+S[j[n+2]] if the seventh collision is detected.

16. A system for determining random values for an stream cipher, comprising:
a memory containing an S-box; and
means for determining at least two sequential random values in parallel utilizing the S-box.

17. The system of claim 16, wherein the means for determining at least two sequential random values in parallel utilizing the S-box further comprises:
means for determining if a collision exists between accesses of the S-box utilized to determine a first of the two sequential random values and accesses of the S-box utilized to determine a second of the two sequential random values; and
means for modifying the determination of the at least two sequential random values based on whether a collision exists between accesses of the S-box.

18. The system of claim 17, wherein the means for determining if a collision exists comprises:
means for determining a state associated with the determination of the at least two sequential random values;
means for comparing values of counters utilized determining the at least two sequential random values; and
means for detecting a collision based on the determined state and the compared values.

19. The system of claim 18, wherein at least two states are associated with the determination of the at least two sequential random values, wherein the counters associated with at least two sequential values comprise first and second i counter values, first and second j counter values and first and second t counter values and wherein means for detecting a collision comprises:
means for detecting a first collision if the determined state is the first state and the second i counter values equals the first j counter value;
means for detecting a second collision if the determined state is the first state and the second j counter values equals the first i counter value;
means for detecting a third collision if the determined state is the first state and the second j counter values equals the first j counter value;
means for detecting a fourth collision if the determined state is the second state, the second j counter values equals the first t counter value; and
means for detecting a fifth collision if the determined state is the second state and the second t counter values equals the first i counter value and the second j counter value is not equal to the first i counter value.

20. The system of claim 19, wherein the means for modifying the determination of the at least two sequential random values based on whether a collision exists between accesses of the S-box comprises:
means for utilizing an S-box value corresponding to the first i counter as the S-box value corresponding to the second i counter if the first collision is detected;
means for utilizing an S-box value corresponding to the first j counter as the S-box value corresponding to the second j counter and preventing writing an S-box value corresponding to the first j counter to a location in the S-box corresponding to the first i counter if the second collision is detected;
means for utilizing an S-box value corresponding to the first i counter as the S-box value corresponding to the second j counter and preventing writing an S-box value corresponding to the first i counter to a location in the S-box corresponding to the first j counter if the third collision is detected;
means for utilizing an S-box value corresponding to the second j counter as the S-box value corresponding to the first t counter if the fourth collision is detected; and
means for utilizing an S-box value corresponding to the second j counter as the S-box value corresponding to the first t counter if the fifth collision is detected.

21. The system of claim 17, further comprising:
means for determining if a collision exists between accesses of the S-box utilized to determine a first portion of the first of the two sequential random values and accesses of the S-box utilized to determine a second portion of the first of the two sequential random values; and
means for determining if a collision exists between accesses of the S-box utilized to determine a first portion of the second of the two sequential random values and accesses of the S-box utilized to determine a second portion of the second of the two sequential random values.

22. The system of claim 21, wherein the means for determining if a collision exists comprises:
means for determining a state associated with the determination of the at least two sequential random values;
means for comparing values of counters utilized determining the at least two sequential random values; and
means for detecting a collision based on the determined state and the compared values.

23. The system of claim 22, wherein at least two states are associated with the determination of the at least two sequential random values, wherein the counters associated with at least two sequential values comprise first and second i counter values, first and second j counter values and first and second t counter values and wherein the means for determining if a collision exists between accesses of the S-box utilized to determine a first portion of the first of the two sequential random values and accesses of the S-box utilized to determine a second portion of the first of the two sequential random values and the means for determining if a collision exists between accesses of the S-box utilized to determine a first portion of the second of the two sequential random values and accesses of the S-box utilized to determine a second portion of the second of the two sequential random values comprises:
means for detecting a first collision if the determined state is the second state and the first i counter value equals the first t counter value; and
means for detecting a second collision if the determined state is the second state and the second t counter values equals the second i counter value.

24. The system of claim 23, wherein the means for modifying the determination of the at least two sequential random values based on whether a collision exists between accesses of the S-box comprises:
means for utilizing an S-box value corresponding to the first j counter as the S-box value corresponding to the first t counter if the first collision is detected; and
means for utilizing an S-box value corresponding to the second j counter as the S-box value corresponding to the second t counter if the second collision is detected.

25. A computer program product for determining random values for an stream cipher, comprising:
a computer readable media having computer readable program code embodied therein, the computer readable program code comprising:
computer readable program code configured to provide a memory containing an S-box; and
computer readable program code configured to determine at least two sequential random values in parallel utilizing the S-box.

26. The computer program product of claim 25, wherein the computer readable program code configured to determine at least two sequential random values in parallel utilizing the S-box further comprises:
computer readable program code configured to determine if a collision exists between accesses of the S-box utilized to determine a first of the two sequential random values and accesses of the S-box utilized to determine a second of the two sequential random values; and
computer readable program code configured to modify the determination of the at least two sequential random values based on whether a collision exists between accesses of the S-box.

27. The computer program product of claim 26, wherein the computer readable program code configured to determine if a collision exists comprises:
computer readable program code configured to determine a state associated with the determination of the at least two sequential random values;
computer readable program code configured to compare values of counters utilized determining the at least two sequential random values; and
computer readable program code configured to detect a collision based on the determined state and the compared values.

28. The computer program product of claim 27, wherein at least two states are associated with the determination of the at least two sequential random values, wherein the counters associated with at least two sequential values comprise first and second i counter values, first and second j counter values and first and second t counter values and wherein the computer readable program code configured to detect a collision comprises:
computer readable program code configured to detect a first collision if the determined state is the first state and the second i counter values equals the first j counter value;
computer readable program code configured to detect a second collision if the determined state is the first state and the second j counter values equals the first i counter value;
computer readable program code configured to detect a third collision if the determined state is the first state and the second j counter values equals the first j counter value;
computer readable program code configured to detect a fourth collision if the determined state is the second state, the second j counter values equals the first t counter value; and
computer readable program code configured to detect a fifth collision if the determined state is the second state and the second t counter values equals the first i counter value and the second j counter value is not equal to the first i counter value.

29. The computer program product of claim 28, wherein the computer readable program code configured to modify the determination of the at least two sequential random values based on whether a collision exists between accesses of the S-box comprises:
computer readable program code configured to utilize an S-box value corresponding to the first i counter as the S-box value corresponding to the second i counter if the first collision is detected;
computer readable program code configured to utilize an S-box value corresponding to the first j counter as the S-box value corresponding to the second j counter and preventing writing an S-box value corresponding to the first j counter to a location in the S-box corresponding to the first i counter if the second collision is detected;
computer readable program code configured to utilize an S-box value corresponding to the first i counter as the S-box value corresponding to the second j counter and preventing writing an S-box value corresponding to the first i counter to a location in the S-box corresponding to the first j counter if the third collision is detected;
computer readable program code configured to utilize an S-box value corresponding to the second j counter as the S-box value corresponding to the first t counter if the fourth collision is detected; and
computer readable program code configured to utilize an S-box value corresponding to the second j counter as the S-box value corresponding to the first t counter if the fifth collision is detected.

30. The computer program product of claim 26, further comprising:
computer readable program code configured to determine if a collision exists between accesses of the S-box utilized to determine a first portion of the first of the two sequential random values and accesses of the S-box utilized to determine a second portion of the first of the two sequential random values; and
computer readable program code configured to determine if a collision exists between accesses of the S-box utilized to determine a first portion of the second of the two sequential random values and accesses of the S-box utilized to determine a second portion of the second of the two sequential random values.

31. The computer program product of claim 30, wherein the computer readable program code configured to determine if a collision exists comprises:
computer readable program code configured to determine a state associated with the determination of the at least two sequential random values;
computer readable program code configured to compare values of counters utilized determining the at least two sequential random values; and
computer readable program code configured to detect a collision based on the determined state and the compared values.

32. The computer program product of claim 31, wherein at least two states are associated with the determination of the at least two sequential random values, wherein the counters associated with at least two sequential values comprise first and second i counter values, first and second j counter values and first and second t counter values and wherein the computer readable program code configured to determine if a collision exists between accesses of the S-box utilized to determine a first portion of the first of the two sequential random values and accesses of the S-box utilized to determine a second portion of the first of the two sequential random values and the computer readable program code configured to determine if a collision exists between accesses of the S-box utilized to determine a first portion of the second of the two sequential random values and accesses of the S-box utilized to determine a second portion of the second of the two sequential random values comprises:
computer readable program code configured to detect a first collision if the determined state is the second state and the first i counter value equals the first t counter value; and
computer readable program code configured to detect a second collision if the determined state is the second state and the second t counter values equals the second i counter value.

33. The computer program product of claim 32, wherein the computer readable program code configured to modify the determination of the at least two sequential random values based on whether a collision exists between accesses of the S-box comprises:
computer readable program code configured to utilize an S-box value corresponding to the first j counter as the S-box value corresponding to the first t counter if the first collision is detected; and
computer readable program code configured to utilize an S-box value corresponding to the second j counter as the S-box value corresponding to the second t counter if the second collision is detected.
